(19) United States
(12) Patent Application Publication
(10) Pub. No.: US 2008/0154746 A1
(43) Pub. Date: Jun. 26, 2008

(54) Gift registry system and method therfore

(75) Inventor: Dean Stark, Toronto (CA)

Correspondence Address: Crockett & Crockett, Suite 400, 24012 Calle De La Plata, Laguna Hills, CA, 92653, US

(73) Assignee: William Ashley Ltd.

(21) Appl. No.: 11/655,553

(22) Filed: Jan. 18, 2007

(30) Foreign Application Priority Data
Dec. 20, 2006 (CA) CA 2571840

(51) Int. Cl. G06F 7/00

(52) U.S. Cl. 705/27

(57) ABSTRACT

A gift registry system is provided. The system comprises a data store configured to store an item code and an item description associated with the item code. The item code corresponds to an item available for selection at a gift seller's establishment and is displayed in conjunction with the item. The system also comprises a portable registry unit in communication with the data store. The registry unit is configured to receive the item code entered by a registrant while attending the gift seller's establishment, acquire from the data store the corresponding item description, present the acquired item description to the registrant, and, communicate an update-registry instruction to effect an update of the gift registry. The system also comprises a registry module that is in communication with the registry unit. The registry module is configured to receive the update-registry instruction from the registry unit, and update the gift registry in accordance with the received instruction. A corresponding method is also provided.

This application claims priority to Canadian Patent Application ______, filed Dec. 20, 2006

### FIELD OF THE INVENTION

The present invention relates to a method and system for generating a gift registry.

### BACKGROUND OF THE INVENTION

Traditionally, guests invited to significant celebrations (such as weddings and showers) bring gifts. Gift registries have evolved as a way of providing gift giving guidance to guests. The celebrants normally attend a retail store and create a gift registry. The means by which the registry is created can vary from using pen and paper to UPC scanners. These systems, however, all have shortcomings. For example, they may not be user-friendly; they may be cumbersome, time consuming and often leave the registrant unsure of whether the correct registry items have been selected.

There remains a need for a gift registry system and method that mitigates or obviates at least some of these problems.

### SUMMARY OF THE INVENTION

A gift registry system is provided. The system comprises a data store configured to store an item code and an item description associated with the item code. The item code corresponds to an item available for selection at a gift seller's establishment and is displayed in conjunction with the item. The system also comprises a portable registry unit in communication with the data store. The registry unit is configured to receive the item code entered by a registrant while attending the gift seller's establishment, acquire from the data store the corresponding item description, present the acquired item description to the registrant, and, communicate an update-registry instruction to effect an update of the gift registry. The system also comprises a registry module that is in communication with the registry unit. The registry module is configured to receive the update-registry instruction from the registry unit, and update the gift registry in accordance with the received instruction.

The system may further comprise a locator associated with the registry unit, the locator is configured to provide the registrant's location at the gift seller's establishment to a representative assigned to the registrant.

The item description may further comprise at least one of a manufacturer's information, item price, and item availability.

The data store may be housed in one of the registry unit and the registry module.

The portable registry unit may comprise an intermediate hold that is configured to hold the update instruction; and, a communicator that is configured to transmit the contents of the hold to the registry module and move the transmitted contents to a log.

The contents of the hold may be transmitted after a defined period of time has elapsed.

### LIST OF FIGURES

FIG. 1 illustrates a schematic view of a gift registry system in accordance with an embodiment of the present invention;

FIG. 2 illustrates a schematic view of a gift registry system in accordance with a further embodiment of the present invention;

FIG. 3 illustrates a user interface screen of a registry unit of a system in accordance with an embodiment of the present invention; and

FIG. 4 illustrates an additional user interface screen of a registry unit of a system in accordance with an embodiment of the present invention;

### DETAILED DESCRIPTION

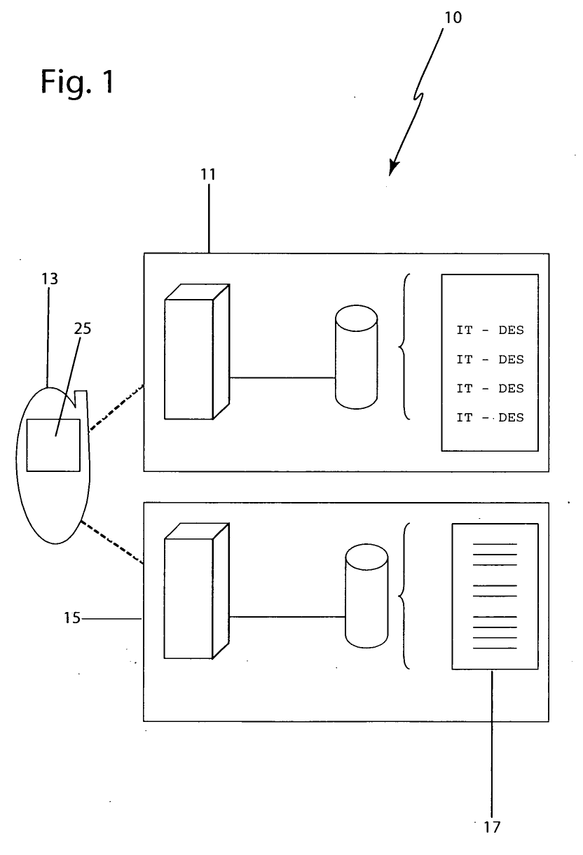

Referring to FIG. 1, an embodiment of a gift registry system 10 is illustrated schematically. The system 10 comprises a data store 11 configured to store an item code (IT) and an item description (DES) associated with the item code. The item code corresponds to an item available for selection at a gift seller's establishment and is displayed in conjunction with the item. The system 10 also comprises a portable registry unit 13 in communication with the data store 11. The registry unit 13 is configured to: receive the item code entered by a registrant while attending the gift seller's establishment; acquire from the data store 11 the corresponding item description; present the acquired item description to the registrant; and, communicate an update-registry instruction to effect an update of the gift registry 17. The system 10 also comprises a registry module 15 that is in communication with the registry unit 13. The registry module 15 is configured to receive the update-registry instruction from the registry unit 13, and update the gift registry 17 in accordance with the received instruction.

In a preferred embodiment, the data store 11 is housed in the registry unit 13. It will be apparent, however, that the data store 11 may also be housed in the registry module 15 or independently of the data store 11 and the registry module 15. The location of the data store 11 may be selected to suit the dictates of the system 10.

The item description preferably comprises at least one of a manufacturer's information (which may include a general item overview, such as the type of product, place of manufacture and materials of manufacture), item price, item availability and an audio description of the selected item. The registry unit 13 is further configured to present the audio description to the registrant. Any suitable audio player may be employed.

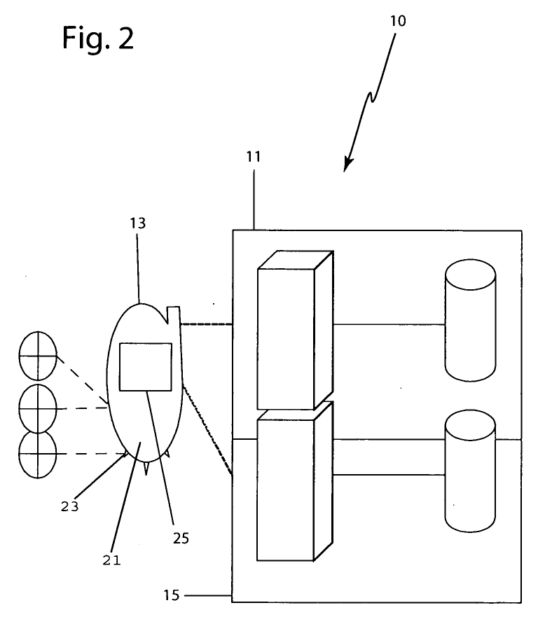

Referring to FIG. 2, an alternate system 10 embodiment is illustrated. The system 10 further comprises a locator 19 associated with the registry unit 13. The locator 19 is configured to provide the registrant's current location at the gift seller's establishment. The locator 19 preferably comprises a transmitter 21 configured to transmit a location signal and at least one receiver 23 configured to receive the location signal and communicate a receiver signal to at least one of the registry module 15 and the registry unit 13. It will be apparent to those skilled in the art that the particular locator 19 configuration employed may be selected according to the dictates of the gift seller's system; any suitable locating means that determines the registrant's location may be employed.

In a preferred embodiment, the system 10 comprises a plurality of receivers 23 positioned throughout the gift seller's establishment and the communicated receiver signals comprise an indication of the receiver 23 closest to the transmitted signal.

The registrant's location may be communicated to the registry unit 13. Preferably, the registrant's location is provided to a representative assigned to the registrant.

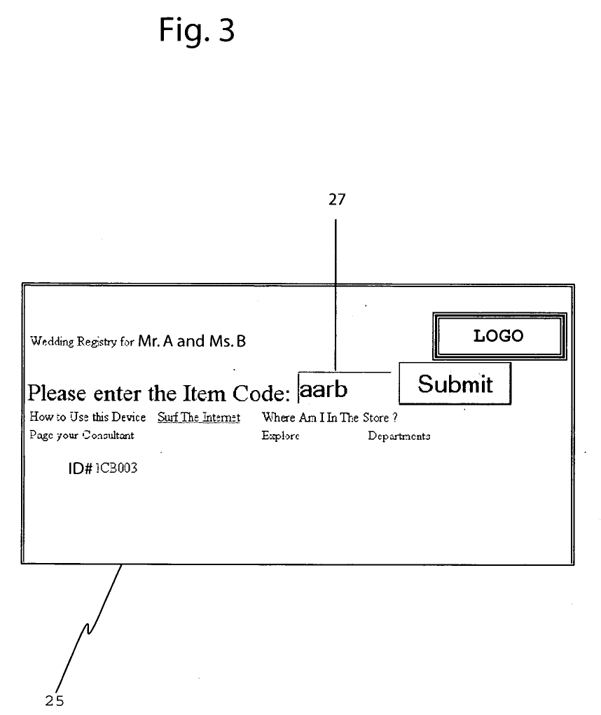

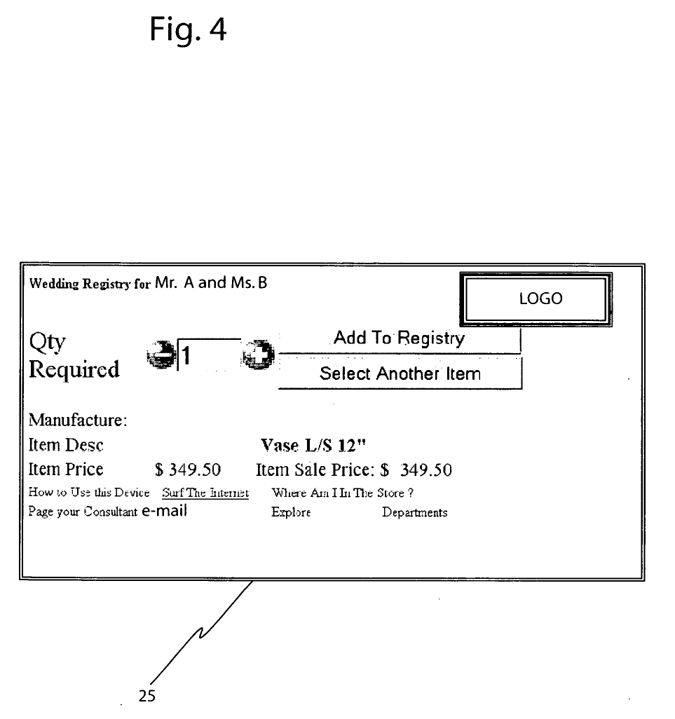

Referring to FIGS. 1 and 2, the registry unit 13 is further configured with a user interface 25, which permits the registrant to interact with the system 10 (create, update and maintain her gift registry). Referring to FIGS. 3 and 4, the user interface comprises at least two configurations. The first configuration, which is illustrated in FIG. 3, provides the registrant with the opportunity to enter the item code (e.g., aarb), corresponding to the item of interest, into the item code field 27. Once entered, the item code may be communicated to the registry module 15. The second configuration, which is illustrated in FIG. 4, supplies the requested item description to the registrant, and provides her with the opportunity to adjust the number required of the selected item and to add the item the registry. The registry unit 13 may be any wireless device known to those skilled in the art. In the present embodiment, the unit 13 is the Nokia 770 Internet Tablet™ (manufactured by Nokia™ of Finland), which communicates with the data store 11 and registry module 15 over a Wi-Fi connection.

In use, the system 10 operates as follows:

A registrant is assigned the portable registry unit 13 for use while attending the gift seller's establishment. The portable unit 13 is identified by an identifier, such as an identification number, an alphanumeric sequence, or any other means known to those skilled in the art. Accordingly, the registrant becomes associated with the identifier so that when a gift seller representative receives a communication from the portable unit (e.g. a request for assistance), the representative will be able to identify the communication as originating from the registrant. The registrant, now in possession of the assigned portable unit 13, is able to visit the various departments of the gift seller's establishment and create and/or modify a gift registry list 17.

In a preferred embodiment, the portable unit 13 announces the particular department as the registrant enters. For example, as the registrant enters the “china room”, the portable unit 13 may announce “welcome to the china room” and provide a brief overview of the types of items available. The portable unit 13 may make this announcement by anyone or a combination of audio, text, still pictures or moving pictures.

As will be apparent to those skilled in the art, the portable unit's location may be determined in any one of a number of ways. For example, the presence of the portable unit 13 may be detected by a proximity detector located (for example) at the entrance of the china room. Alternatively, the portable unit's location may be determined at any given time with the use of a locator 19, associated with the portable unit 13, which is in communication with a series of position detectors located throughout the gift seller's establishment (not shown). The locating means selected may be determined according the gift seller's particular needs.

It will also be apparent to those skilled in the art that the department announcement may reside in any one of a number of places. For example, the announcement may reside locally in the registry unit 13. In this configuration, the registry unit 13, on entering a department, initiates a sequence of instructions including accessing the announcement and presenting it to the registrant. Alternatively, the announcement may reside remotely. In this configuration, the registry unit 13, on entering a department, initiates a sequence of instructions including receiving (by a request or a push) the announcement and presenting it to the registrant.

Once in the department, and after having been presented the announcement, the registrant may view the items that are available for selection. Each available item is displayed in conjunction with a corresponding item code. If the registrant decides to investigate an item further, she enters the item code into the item code field 27 of the portable unit's user interface 25. The item code may be entered by any of a number of means known in the art (e.g., keyboard, touch pad). This item code is preferably an alphanumeric sequence. Alternatively, the item code may be a UPC bar code or a proprietary bar code, and a scanning device is used to enter the item code.

In a still further alternate embodiment, the registrant may enter the item code vocally. For example, the portable unit 13 may be configured with a voice receiver (e.g., microphone), into which the registrant speaks the item code. The spoken item code is then communicated to a voice recognition unit, which converts it into a form that can be used by the data store. The voice recognition unit (not shown) may host and execute any one of a number of known voice recognition applications. The voice recognition unit may be located remotely, in which case, the spoken item code may be transmitted to the voice recognition unit by any one of a number of known communication protocols. For example, the spoken item code may be transmitted employing voice over Internet protocol (voip).

The item code that has been entered into the item code field 27 forms the basis for acquiring additional item information, an item description (DES). In a preferred embodiment, the item code forms the basis of a database query. The portable unit 13, having received the item code of interest, queries data store 11, which is configured to store the item code (IT) and the corresponding item description (DES). The data store 11, having received the query from the portable unit 13, retrieves the item description (DES) and provides it to the portable unit 13.

Once the portable unit 13 acquires the requested item description, it is presented to the registrant. The item description may be any one or a combination of audio, text, still pictures or moving pictures. In a preferred embodiment, the item description comprises an audio description of the item of interest. As will be apparent to those skilled in the art, any suitable audio format may be used to store and present the audio description, and the portable unit 13 would be configured accordingly. In the present embodiment, the audio description is stored in an mpeg-layer-3 format, as is known in the art.

The data store 11 preferably comprises a database application, as is known in the art, as well as storage space to hold the item description component (e.g. audio, text, image). Any suitable database application may be employed.

The data store 11 may reside on the portable unit 13, or it may be located remotely. If located remotely, the portable unit is configured with communication means for querying the remote data store 11 and acquiring the desired item description. The communication means selected may be any suitable wireless communication means known to those in the art using a communication protocol that suits the particular system requirements (e.g., Wi-Fi).

In the present embodiment, the data store 11 resides locally on the portable unit 13, stored in the portable unit's memory stores.

Referring to FIG. 3, in addition to the opportunity to enter an item code, the user interface 25 of the portable unit 13 provides a number of other avenues for interaction. For example:
1. Instructions on how to use the portable unit 13;
2. Internet browser—the registrant may launch an Internet browser to retrieve any required additional information;
3. Location—the registrant may determine her location in the gift seller's establishment, by the means previously described;
4. Request Assistance—the registrant may request assistance from one of the gift seller's representatives. This request may be sent by any of a number of known means;
5. Send an e-mail; and
6. Explore the various departments available at the gift seller's establishment.

As stated previously, the acquired item description preferably comprises an audio description of the item. It may also comprise manufacturer information, an item price (as well as a current sale price) and item features (e.g. dimensions).

Referring to FIG. 4, once the acquired item description is presented, the registrant is presented with a number of options. If the registrant chooses to add the item to the gift registry, the quantity added may be adjusted. Once the quantity is determined, the registrant may select to add the item to the registry. If the registrant chooses not to add the item, he or she may select to view an item description for another item available for selection.

When the registrant selects to add a viewed item to the registry, an update-registry instruction is communicated so as to effect an update of the gift registry. The update instruction may be communicated according to the dictates of the gift seller's particular system. For example, the instructions may be communicated: individually as created (“real-time”), in batches (e.g., after the passage of an interval of time, or after a defined number of instructions has been created), or as a whole once the registrant has completed the selection session.

In a preferred embodiment, the update registry instructions are communicated in batches. In this configuration, the registry unit 13 further comprises an intermediate hold (or current directory) configured to hold the update instruction; and, a communicator configured to transmit the contents of the hold to the registry module and move the transmitted contents to a historical log. The registry unit 13 then initiates a sequence of instructions including: checking the contents of the current directory; if the current directory contains an update instruction, communicating the instruction to the registry module 15; moving the contents of the current directory to a historical directory (or log); repeating previous sequence of steps in response to a defined condition being satisfied (e.g., a defined period of time has passed or a defined number of update instructions has been stored in the current directory).

The contents of the historical log may be communicated to the registry module 15 once the registrant's session is complete. In this manner, the contents of the historical log may be compared to the previously communicated update instructions and serve as an en-or check.

The update registry instruction is communicated to the registry module 15 by any known means in the art. The registry module 15 is preferably located remotely. A copy of either of the registry 17 or the registry module 15 may be stored locally on the registry unit 13, and a master registry list 17 may be stored remotely. The copy may then be modified during the registrant's visit, with the master being modified on the visit's completion.

The registry module 15 preferably comprises a database application, as is known in the art, as well as storage space to hold the registry 17. Any suitable database application may be employed.

The above description is intended in an illustrative rather than restrictive sense. Variations may be apparent to those skilled in the art without departing from the spirit and scope of the invention as defined by the claims set out below.

1. A gift registry system comprising:
a data store configured to store an item code and an item description associated with the item code:
the item code corresponding to an item available for selection at a gift seller's establishment and being displayed in conjunction with the item, and
the item description comprising at least one of an audio, text, still picture and moving picture description of the associated item;
a portable registry unit in communication with the data store, the registry unit configured to:
receive the item code entered by a registrant while attending the gift seller's establishment,
acquire from the data store the associated item description,
present the acquired item description to the registrant, and,
communicate an update-registry instruction to effect an update of the gift registry; and,
a registry module in communication with the registry unit, the registry module configured to:
receive the update-registry instruction from the registry unit, and
update the gift registry in accordance with the received instruction.

2. A system according to claim 1, further comprising a locator associated with the registry unit, the locator configured to provide the registrant's location at the gift seller's establishment to a representative assigned to the registrant.

3. A system according to claim 2, wherein the locator comprises a transmitter configured to transmit a location signal and at least one receiver configured to receive the location signal and communicate a receiver signal to at least one of the registry module and the registry unit.

4. A system according to claim 3 further comprising a plurality of receivers positioned throughout the gift seller's establishment and the communicated receiver signals comprise an indication of the receiver closest to the transmitted signal.

5. A system according to claim 1, wherein the item description further comprises at least one of a manufacturer's information, item price, and item availability.

6. A system according to claim 1, wherein the data store is housed in the registry unit

7. A system according to claim 1, wherein the data store is housed in the registry module.

8. A system according to claim 1, wherein the portable registry unit further comprises:
an intermediate hold configured to hold the update instruction; and, a communicator configured to transmit the contents of the hold to the registry module and move the transmitted contents to a log.

9. A system according to claim 8, wherein the contents of the hold is transmitted after a defined period of time has elapsed.

10. A gift registry system comprising:
a data store configured to store an item code and an item description associated with the item code:
the item code corresponding to an item available for selection at a gift seller's establishment and being displayed in conjunction with the item, and
the item description comprising an audio description of the associated item;
a portable registry unit in communication with the data store, the registry unit configured to:
receive the item code entered by a registrant while attending the gift seller's establishment,
acquire from the data store the associated item description,
present the acquired item description to the registrant, and,
communicate an update-registry instruction to a registry module configured to receive the update-registry instruction from the registry unit, and update the gift registry in accordance with the received instruction.

11. A system according to claim 10, further comprising a locator associated with the registry unit, the locator configured to provide the registrant's location at the gift seller's establishment to a representative assigned to the registrant.

12. A system according to claim 10, wherein the item description further comprises at least one of a manufacturer's information, item price, and item availability.

13. A system according to claim 10, wherein the data store is housed in the registry unit

14. A system according to claim 10, wherein the data store is housed in the registry module.

15. A system according to claim 10, wherein the portable registry unit comprises:
an intermediate hold configured to hold the update instruction; and, a communicator configured to transmit the contents of the hold to the registry module and move the transmitted contents to a log.

16. A system according to claim 15, wherein the contents of the hold is transmitted after a defined period of time has elapsed.
